(19) United States
(12) Patent Application Publication
(10) Pub. No.: US 2011/0287749 A1
(43) Pub. Date: Nov. 24, 2011

(54) REMOTE BABYSITTING MONITOR

(75) Inventor: Pinhas Sherf, Bnei Brak (IL)

(73) Assignee: ASER RICH LIMITED, London (GB)

(21) Appl. No.: 13/145,888

(22) PCT Filed: Jan. 24, 2010
(86) PCT No.: PCT/IL10/00057

§ 371 Date: Aug. 15, 2011

Related U.S. Application Data
(60) Provisional application No. 61/146,664, filed on Jan. 23, 2009.

(51) Int. Cl. H04W 4/00

(52) U.S. Cl. 455/414.1

(57) ABSTRACT

The invention herein disclosed provides means and methods for monitoring the condition of infants, young children, the elderly and the incapacitated from a remote location simply and efficiently and can be regarded as a remote babysitting system. A system for monitoring remote locations comprising a telephonic device adapted to pick up the line automatically when called by a celler, said telephonic device being acoustically coupled to its surroundings, wherein said caller may listen to said surroundings from a remote location is herein described.

### FIELD OF THE INVENTION

The present invention relates to a method and apparatus for monitoring remote sites by means of a cellular telephonic device or cell phone.

### BACKGROUND OF THE INVENTION

In the prior art, use of various means to monitor the status of one's home has been shown. For example, burglar alarm systems that call a given phone have been in existence for decades. More recently, transmission of information from a remote location has become commonplace, for instance by use of webcams (cameras attached to computers connected to the internet).

For example, Japanese patent application JP2007233733A2 provides a method to flexibly and rapidly cope with improvements and changes to house equipment or a change of market needs in a home network. This is based on control and monitoring of the house equipment performed in each of a plurality of subsystems that constitute a home network using a general-purpose communication protocol. Because cooperation of the subsystems is performed via the home network, change of market needs or functional improvements to the house equipment can be flexibly and rapidly coped with as compared to a precedent wherein all pieces of the house equipment are connected to one master unit. It will be appreciated however that this system is rather complex, and is based on the existence of an entire home netwrok which will tend to increase the cost and hardware requirements of the system.

Combinations have been proposed wherein internet-connected webcams supply information to one's cell phone, which generally is required to be a ‘Gen 3’ or internet-capable phone.

(See for example http://tech.yahoo.com/blogs/raskin/225, and http://www.oreillynet.com/pub/a/wireless/2001/07/23/monitor.html).

However it will be appreciated that the requirement of internet connections and gen-3 cell phones may impose an unnecessarily high financial burden on the user, and also will not be possible where internet infrastructure and/or Gen-3 infrastructure is lacking.

Of course the most important need for a family is to be able to simply monitor the condition of infants, young children, the elderly and the incapacitated from a remote location simply and efficiently.

Hence, an improved method for remote monitoring is still a long felt need.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which

FIG. 1 presents a group of children being remotely monitored by the system of the present invention.

FIG. 2a presents a flowchart detailing operation of the method of the present invention without remote activation.

FIG. 2b presents a flowchart detailing operation of the method of the present invention with remote activation.

### SUMMARY OF THE INVENTION

The present invention comprises a system and method for remotely monitoring sites by telephonic means. The key element of the system is a simply modified cell phone of the most basic variety, not requiring interne connectivity or advanced functionality. By means of this element, the user may listen to or view remote locations in a surreptitious fashion, at will.

The invention herein disclosed provides means and methods for monitoring the condition of infants, young children, the elderly and the incapacitated from a remote location simply and efficiently.

It is within the core of the present invention to provide a system for monitoring remote locations comprising a telephonic device adapted to pick up the line automatically when called by a caller, said telephonic device being acoustically coupled to its surroundings, wherein by a caller may listen to said surroundings from a remote location.

It is an object of the present invention to provide the aforementioned system wherein said telephonic device is further adapted to pick up the line silently without ringing, such that said caller being allowed to monitor said surroundings without being noticed.

It is an object of the present invention to provide the aforementioned system, wherein said telephonic device is a cellular phone.

It is an object of the present invention to provide the aforementioned system, wherein said telephonic device is hidden within a commonplace object.

It is an object of the present invention to provide the aforementioned system, wherein said commonplace object is selected from a group consisting of: clock, table, chair, wall, picture, mirror, safe, bed, door, book, and pen.

It is an object of the present invention to provide the aforementioned system, wherein said telephonic device is further provided with sensors selected from a group consisting of: video, vibration, pressure, temperature, acceleration, and motion detectors; wherein said sensors are adapted to be activated by means of numeric codes entered by said caller; further wherein said sensor readings are reported by said telephonic device by means selected from a group consisting of: numerical codes, tones, voice, image, and video.

It is an object of the present invention to provide the aforementioned system, wherein said telephonic device is adapted to call a predetermined number when a certain predetermined threshold of sensor level is exceeded.

It is an object of the present invention to provide the aforementioned system, wherein said telephonic device is adapted to pick up only when called from telephone numbers on a predetermined list of numbers.

It is an object of the present invention to provide the aforementioned system, wherein said telephonic device is further provided with outputs selected from a group consisting of: speakers, relays, lights, air conditioner controls, boiler controls, oven controls, and security system controls; further wherein said sensors are activated by means selected from a group consisting of: numerical codes, tones, voice.

It is a further object of the present invention to provide a method for monitoring remote locations comprising steps of:

(a) providing a system for monitoring remote locations comprising a telephonic device adapted to pick up the line automatically when called by a caller, said telephonic device being acoustically coupled to its surroundings, wherein said caller may listen to said surroundings from a remote location;

(b) adapting said telephonic device to pick up the line automatically when a call received to said telephonic device

(c) picking up the line of said telephonic device in an automatic manner when said telephonic device called by said caller;

(d) acoustically coupling said telephonic device to its surroundings;

(e) listening to said surroundings of said telephonic device from said remote location of said caller; and,

(f) monitoring said surroundings of said telephonic device from said remote location of said caller in an unnoticed manner.

It is an object Of the present invention to provide the aforementioned method, wherein said step of picking up the line of said telephonic device is performed without ringing of said telephonic device.

It is an object of the present invention to provide the aforementioned method, wherein said step of providing a system for monitoring remote, wherein said telephonic device is a cellular phone. It is an object of the present invention to provide the aforementioned method, further comprising step of hiding said telephonic device within a commonplace object.

It is an object of the present invention to provide the aforementioned method, further comprising step of selecting said commonplace object from a group consisting of: clock, table, chair, wall, picture, mirror, safe, bed, door, book, and pen.

It is an object of the present invention to provide the aforementioned method further comprising step of providing said telephonic device with sensors; said sensors selected from a group consisting of: video, vibration, pressure, temperature, acceleration, and motion detectors.

It is an object of the present invention to provide the aforementioned method, further comprising step of activating said sensors by means of numeric codes entered by said caller said method further comprising step of reporting the readings of said sensors to said caller by said telephonic device by means selected from a group consisting of: numerical codes, tones, voice, image, and video.

It is an object of the present invention to provide the aforementioned method, further comprising step of calling to a predetermined number from said telephonic device when a certain predetermined threshold of sensor level in said sensors is exceeded.

It is an object of the present invention to provide the aforementioned method said step of picking up the line of said telephonic device is performed only upon recognition of a telephone number selected from a predetermined list of numbers. It is an object of the present invention to provide the aforementioned method, further comprising step of providing said telephonic device with outputs selected from a group consisting of :speakers, relays, lights, air conditioner controls, boiler controls, oven controls, and security system controls; wherein said sensors are activated by means selected from a group consisting of: numerical codes, tones, voice.

It is an object of the present invention to provide the aforementioned method, wherein said step of listening to said surroundings of said telephonic device from said remote location of said caller is performed by means of a fixed-airtime cellular connection.

It is an object of the present invention to provide the aforementioned method, wherein said fixed-airtime cellular connection is provided by means selected from a group consisting of: SIM card, prepaid phone card, and numeric code. While the invention is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a cellular remote monitor.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer e.g, 1, 2, or 10.

It is a core objective of the invention herein disclosed to provide means and methods for monitoring the condition of infants, young children, the elderly and the incapacitated from a remote location simply and efficiently.

According to a preferred embodiment of the present invention, a standard cell phone is modified such that it ‘picks up’ automatically when called. Many cell phones have such a setting, for example for use when driving. If no such setting is available, the circuitry of the cell phone may be modified to answer automatically when dialed. By answering immediately, the ring is avoided. In an alternative embodiment of the invention, the ring is avoided by setting the phone volume to a silent setting. A cell phone so provided to ‘pick up’ without ringing is then embedded into a common object such as a clock, table, picture, window, chair, safe, or the like, with care being taken that the microphone is amply exposed to the ambient sound environment. This phone will be referred to as the ‘monitor cell phone’. The location of this device will be referred to as the ‘remote location’. It will be understood that a regular telephone with the ringer similarly deactivated and provided with automatic pickup will also serve the same purpose as a cell phone.

Already at this point, such a device has great utility, since one can call the number associated with the monitor cell phone, and listen to the environment of the monitor cell phone from around the world. Thus, for example, a parent can monitor the activity of a child from a distance. In one embodiment of the invention, the monitor cell phone is provided with a speaker, such that the user can be heard in the surroundings of the monitor cell phone. In another of the embodiment, no such speaker is provided, such that there is no risk of the monitor cell phone being detected. This will have utility in applications such as security monitoring, where a home owner might want to be able to monitor the sounds in his home without revealing that this monitoring was taking place.

In one embodiment of the device, a microphone is provided with the monitor cell phone. In another embodiment of the device, video capabilities are provided to the monitor cell phone, which can then be used to monitor the remote location visually. In still another embodiment of the invention, further inputs are provided to the cell phone by means which will be clear to one skilled in the art, such as temperature sensors, humidity sensors, movement sensors, pressure sensors, acceleration detectors, vibration sensors, and the like. In yet another embodiment of the invention, the cell phone is provided with outputs, such as light controls, relays, air conditioner controls, boiler activators, oven controls, and the like, implementing in effect a ‘smart house’ by means of cell phone. It will be obvious to one skilled in the art that such control over multiple devices and sensors may be easily provided for by means of numeric codes input into the user phone to control operation of the monitor cell phone.

In one embodiment of the invention, the monitor cell phone will respond only to a predetermined list of phone numbers, and will not pick up for any numbers not on this list. By this means, undesired snooping is prevented.

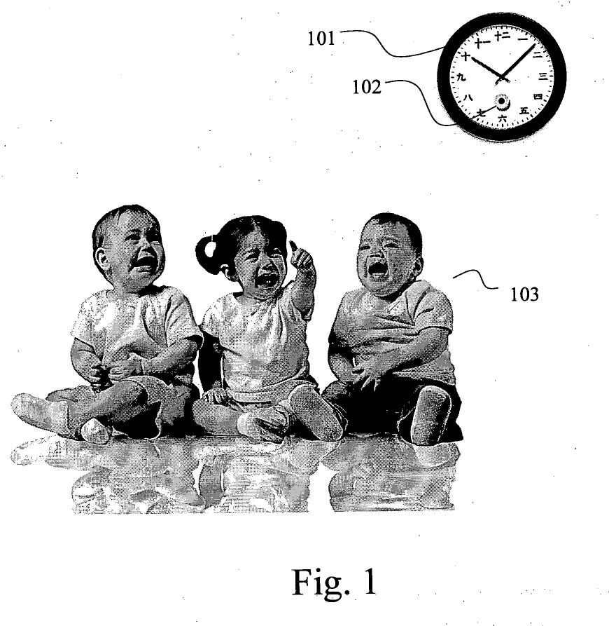

In FIG. 1 a basic configuration of the device is shown. A cellular phone or other telephonic device 102 is hidden within the clock 101. The microphone of the telephonic device is visible on the face of the clock, and is acoustically coupled to its surroundings. By calling this telephonic device, the peaceful slumber or disquietude of one's children 103 may be monitored.

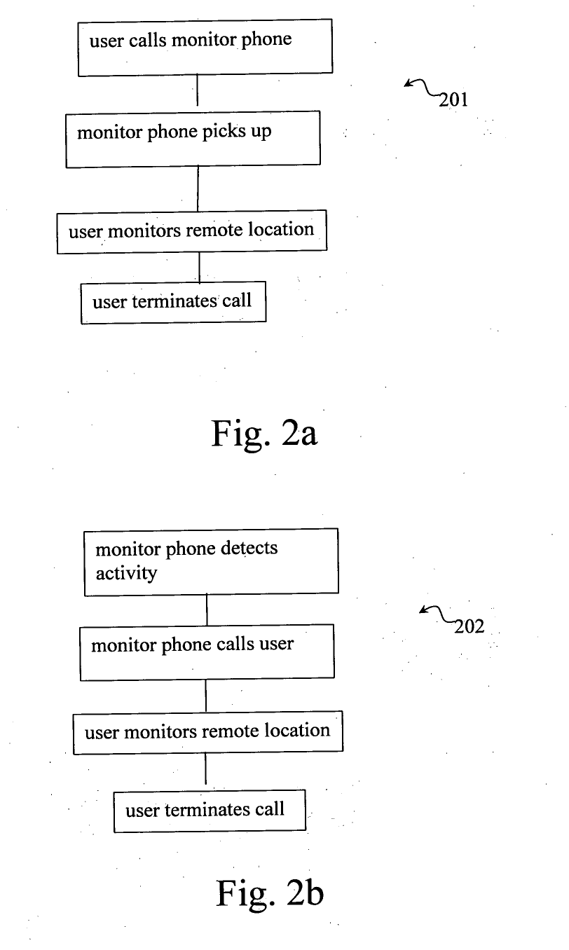

In FIG. 2a the basic method of operation 201 of the device is shown. The first step of this method consists of calling the phone that is hidden within the remote location (the monitor phone). The monitor phone is adapted to pick up the line automatically, in a preferred embodiment without ringing. When the caller is finished monitoring, he hangs up and so terminates the call.

In FIG. 2b an alternative method of operation 202 of the device is shown. The first step of this method is activated when the monitor phone detects some activity, such as noise above a certain threshold, movement, or the like. The monitor phone is adapted to call a predetermined number or numbers when this occurs. The entity receiving this call may then monitor the surroundings of the monitor phone, and when said entity is finished monitoring, it may hang up and so terminates the call.

It is within provision, of the invention that certain arrangements be made with cellular providers to allow for cheaper access to one's monitor phone. For example, pre-paid SIM cards will be made available with a certain number of minutes of air time provided. Since two-way communication is not necessary in certain embodiments of the device, this air time may be substantially cheaper than otherwise. By placing the pre-paid SIM card in one's phone, or alternately by entering a code provided for this purpose, one has access to the monitor phone for a fixed amount of air time and a fixed cost. This air time may be used at will. It will be clear to one skilled in the art that this method may also be used to provide unique access; either the user's cellular phone is restricted to only call the monitor phone, or the monitor phone is restricted to receive calls only from the user's cell phone, or both.

1-21. (canceled)

22. A system for monitoring remote locations comprising a telephonic device adapted to pick up the line automatically when called by a caller, said telephonic device being acoustically coupled to its surroundings, wherein said caller may listen to said surroundings from a remote location.

23. The system of claim 22, wherein said telephonic device is further adapted to pick up the line silently without ringing, such that said caller is able to monitor said surroundings without being noticed.

24. The system of claim 22, wherein said telephonic device is a cellular phone.

25. The system of claim 22, wherein said telephonic device is hidden within a commonplace object.

26. The system of claim 22, wherein said telephonic device is further provided with sensors selected from a group consisting of: video, vibration, pressure, temperature, acceleration, and motion; wherein said sensors are adapted to be activated by means of numeric codes entered by said caller; and further wherein said sensors' readings are reported via said telephonic device by means selected from a group consisting of :
numerical codes, tones, voice, image, and video.

27. The system of claim 26, wherein said telephonic device is adapted to call a predetermined number when a certain predetermined threshold of sensor level is exceeded.

28. The system of claim 22, wherein said telephonic device is adapted to pick up only when called from telephone numbers on a predetermined list of numbers.

29. The system of claim 22, wherein said telephonic device is further provided with outputs selected from a group consisting of: speakers, relays, lights, air conditioner controls, boiler controls, oven controls, and security system controls; further wherein said outputs are activated by means selected from a group consisting of: numerical codes, tones, voice.

30. A method for monitoring remote locations comprising steps of:
(a) providing a system for monitoring remote locations comprising a telephonic device adapted to pick up the line automatically when called by a caller, said telephonic device being acoustically coupled to its surroundings, wherein said caller may listen to said surroundings from a remote location;
(b) adapting said telephonic device to pick up the line automatically when a call is received to said telephonic device;
(c) picking up the line of said telephonic device in an automatic manner when said telephonic device is called by said caller;
(d) acoustically coupling said telephonic device to its surroundings;
(e) monitoring said surroundings of said telephonic device from said remote location of said caller in an unnoticed manner.

31. The method of claim 30, wherein said step of picking up the line of said telephonic device is performed without ringing of said telephonic device.

32. The method of claim 30, wherein said telephonic device is a cellular phone.

33. The method of claim 30, further comprising a step of hiding said telephonic device within a commonplace object.

34. The method of claim 33, further comprising a step of selecting said commonplace object from a group consisting of: clock, table, chair, wall, picture, mirror, safe, bed, door, book, and pen.

35. The method of claim 30, further comprising a step of providing said telephonic device with sensors; said sensors selected from a group consisting of: video, vibration, pressure, temperature, acceleration, and motion.

36. The method of claim 35, further comprising a step of activating said sensors by means of numeric codes entered by said caller said method further comprising step of reporting the readings of said sensors to said caller by said telephonic device by means selected from a group consisting of: numerical codes, tones, voice, image, and video.

37. The method of claim 35, further comprising a step of calling a predetermined number from said telephonic device when a certain predetermined threshold of sensor level in said sensors is exceeded.

38. The method of claim 30, wherein said step of picking up the line of said telephonic device is performed only upon recognition of a telephone number selected from a predetermined list of numbers.

39. The method of claim 30, further comprising a step of providing said telephonic device with outputs selected from a group consisting of: speakers, relays, lights, air conditioner controls, boiler controls, oven controls, and security system controls; wherein said sensors are activated via said telephonic device by means selected from a group consisting of: numerical codes, tones, voice.

40. The method of claim 30, wherein said step of listening to said surroundings of said telephonic device from said remote location of said caller is performed by means of a fixed-airtime cellular connection.

41. The method of claim 40, wherein said fixed-airtime cellular connection is provided by means selected from a group consisting of: SIM card, prepaid phone card, and numeric code.
